(19) United States
(12) Patent Application Publication
(10) Pub. No.: US 2009/0198490 A1
(43) Pub. Date: Aug. 6, 2009

(54) RESPONSE TIME WHEN USING A DUAL FACTOR END OF UTTERANCE DETERMINATION TECHNIQUE

(75) Inventors: JOHN W. ECKHART, BOCA RATON, FL (US); JONATHAN PALGON, BOYNTON BEACH, FL (US); JOSEF VOPICKA, PRAHA (CZ)

Correspondence Address: WOLF GREENFIELD & SACKS, P.C., 600 ATLANTIC AVENUE, BOSTON, MA, 02210-2206, US

(73) Assignee: INTERNATIONAL BUSINESS MACHINES CORPORATION, ARMONK, NY (US)

(21) Appl. No.: 12/027,017

(22) Filed: Feb. 6, 2008

(51) Int. Cl. G10L 11/02

(52) U.S. Cl. 704/215; 704/E19.003

(57) ABSTRACT

The present invention discloses a solution for a speech processing system to determine end-of-utterance (EOU) events. The solution is a modified dual factor technique, where one factor is based upon a number of silence frames received and a second factor is based upon an end-of-path occurrence. The solution permits a set of configurable timeout delay values to be established, which can be configured on an application specific basis by application developers. The solution can speed up EOU determinations made through a dual factor technique, by situationally making finalization determination before a silence frame window is full.

### BACKGROUND

1. Field of the Invention

The present invention relates to the field of speech processing technologies and, more particularly, to using a combination of end-of-path and silence frame detections with inclusive finalization timeouts to detect end of utterance (EOU) events in a speech processing system.

2. Description of the Related Art

When developing applications that employ speech recognition, one of the main goals is always to create a positive user experience. For most application designers, this means developing an application that acts more like a human than a machine. In applications employing speech recognition, this goal equates to having an application that detects speech directed at the application, understands speaker pauses/breaks, reacts to recognized phrases, and provides a response that the request was understood.

One of the recurring problems with modem speech recognition is their ability to accurately determine the end of speech. Adding to this difficulty, many application designers desire control over the length of time for inter-word pauses before the recognition engine determines that the speaker has stopped speaking. Thus, to satisfy both users and application designers, an intuitive mechanism for detecting end-of-utterances is necessary, which can still be configured in an application specific manner to establish application specific inter-word pauses.

End of utterance (EOU) detection difficulties have been addressed in various ways in the past, each of which has its own significant drawbacks. One technique for resolving EOU problems is to employ a push-to-talk (PTT) technology, which forces the speaker to notify the application of an EOU event. PTT technologies however require explicit user feedback regarding EOU events, which many users find cumbersome and/or unnatural.

Another EOU problem mitigation technique involves segmenting an incoming audio stream up into a set of data frames, each of which is labeled as a speech frame or a silence frame. Whenever a definable quantity of consecutive silence frames are detected, the speech recognition engine can assume that a speaker has stopped speaking. In relatively quiet environments, using consecutive silence frames to determine EOU events, works relatively well. In noisy environments, however, loud ambient noises can easily cause one or more frames to be marked as speech, which can be problematic because each mis-marked frame causes a consecutive number of silence frames (for EOU determination purposes) to be reset. Thus, in noisy environments, use of consecutive silence frames for EOU determinations often results in excessively long delays in deciding an EOU occurrence.

An enhancement of the silence frame based technique, referenced as a dual factor technique, permits an EOU determination to be made from a combination of end-of-path determinations and a quantity of consecutive silence frames. The dual factor technique tends to perform better in a variety of environments (silent as well as somewhat noisy environments) than techniques based on silence frames or end-of-path determinations alone. The problem with existing dual factor techniques is that under certain conditions, they wait a relatively long time before making a determination.

### SUMMARY OF THE INVENTION

The present invention represents an enhancement of a dual factor technique for end of utterance (EOU) determinations. The invention speeds up the EOU determination process when an EOU determination is based upon a number of silence frames. More specifically, situations exist currently where conventional dual factor EOU determinations must wait until an entire silence frame window is full before making an EOU determination. Once a tentative EOU determination is made based upon a number of silence frames, a sending of audio frames to a decoder is halted to be resumed only after the tentative EOU determination is finalized, which currently requires the silence frame window to be full. In many instances, however, a sufficient number of frames are present in the silence frame window to make a definitive determination. That is, no matter what the remaining frames are, the ultimate determination will not change. The present invention looks for such a state, and makes an immediate EOU finalization determination even before the silence frame window is completely filled. This improves efficiency by reducing a delay period for EOU determinations, while having no negative effect on accuracy.

The present invention can be implemented in accordance with numerous aspects consistent with the materials presented herein. One aspect of the present invention can include a system for determining end of utterance events (EOU). The system can include a frame based segmenter, a frame labeler, a decoder, a silence EOU detector, an end-of-path manager, and an EOU detector. The frame based segmenter can be configured to segment an incoming audio stream into a sequence of frames. The frame labeler can label frames created by the frame based segmenter as silence frames and as speech frames. The decoder can match audio contained in speech frames against entries in a speech recognition grammar and can perform programmatic actions based upon match results. The silence EOU detector can initiate a tentative end of utterance event when a number of silence frames within a sequence of frames exceeds a previously defined threshold. The end-of-path manager can initiate a tentative end of utterance event when an end of a path of an enabled recognition grammar is determined. The EOU detector can establish a waiting period and a set of conditions for converting a tentative end of utterance event into a finalized end of utterance event and for releasing a tentative end of utterance event that is not to be finalized.

Another aspect of the present invention can include software for determining an EOU event, which includes a silence component, a path component, and a finalization component. The silence component can initiate a silence induced EOU event based upon a number sequential frames labeled as silence that are received. The path component can initiate an end-of-path induced EOU event based upon programmatic determinations that terminal nodes of recognition grammar paths for a speech input have been reached. The finalization component can delay determinations of EOU events initiated by the silence component and the path component for a defined duration, can perform at least one determination as to whether the initiated EOU event is to be finalized, and can then either finalize the initiated EOU event or ignore the initiated EOU event based upon the performed determination.

Still another aspect of the present invention can include a method for determining EOU events in a speech processing situation. The method can segment an incoming audio stream into a set of frames. Each of the frames can be labeled as containing speech or silence. An end-of-path determination can be made. The method can wait for an application requested time out period to expire before finalizing a result. During this time, speech frames can continue to be speech recognized. The end-of-path determination can be selectively revoked depending upon results of the speech recognitions occurring during the requested time out period. When the requested time out period expires and when results have not been revoked, an EOU event can be initiated based upon a finalized end-of-path determination.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram showing a speech processing system that determines end of utterance (EOU) events based upon both end-of-path determinations and silence determinations, both of which include a configurable finalization timeout parameter.

FIG. 2 is a set of flow charts illustrating methods for end of path based EOU determinations and silence based EOU determinations in accordance with an embodiment of the inventive arrangements disclosed herein.

### DETAILED DESCRIPTION OF THE INVENTION

The present invention discloses a solution for a speech processing system to determine end-of-utterance (EOU) events. The solution is a modified dual factor technique, where one factor is based upon a number of approximately continuously silence frames received and a second factor is based upon an end-of-path occurrence. The solution permits a set of configurable timeout delay values to be established, which can be configured on an application specific basis by application developers. The solution can speed up EOU determinations made through a dual factor technique, which are partly based upon a number of silence frames received, which improves efficiency of the modified dual factor technique without impacting accuracy.

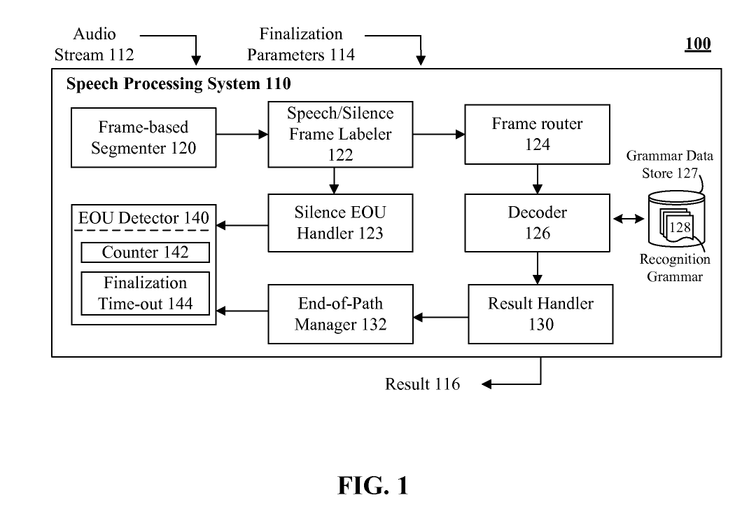

FIG. 1 is a schematic diagram 100 illustrating an embodiment of the solution. The diagram 100 shows a speech processing system 110, which processes an audio steam 112 to ultimately produce a result 116, such as speech recognized text or results from one or more programmatic actions triggered by speech recognized audio. The audio stream 112 can be processed by the frame based segmenter 120, which segments the audio into a sequence of frames. A frame labeler 122 can then analyze each frame and can label each as a silence frame or a speech frame. A speech frame is one determined to contain speech to be decoded. A silence frame is one determined to contain either silence or ambient noise, neither of which are to be decoded. Depending upon how a frame is labeled, the frame router 124 can properly route the frames to the decoder 126 for processing or not. The decoder 126 can utilize one or more speech recognition grammars 128 stored in a data store 127 when decoding the frames. Programmatic actions triggered based upon decoder 126 processed input can be handled by result handler 130.

Two different occurrences can trigger a tentative EOU event; one being determined by the silence EOU handler 123, the other being determined by the end-of-path manager 132. Once a tentative EOU event occurs, an EOU detector 140 can determine whether conditions exist to finalize the tentative EOU occurrence to produce a confirmed EOU event or whether conditions exist for negating the tentative EOU event. The detector 140 can use a counter 142 and a finalization timeout variable 144 to make its determinations.

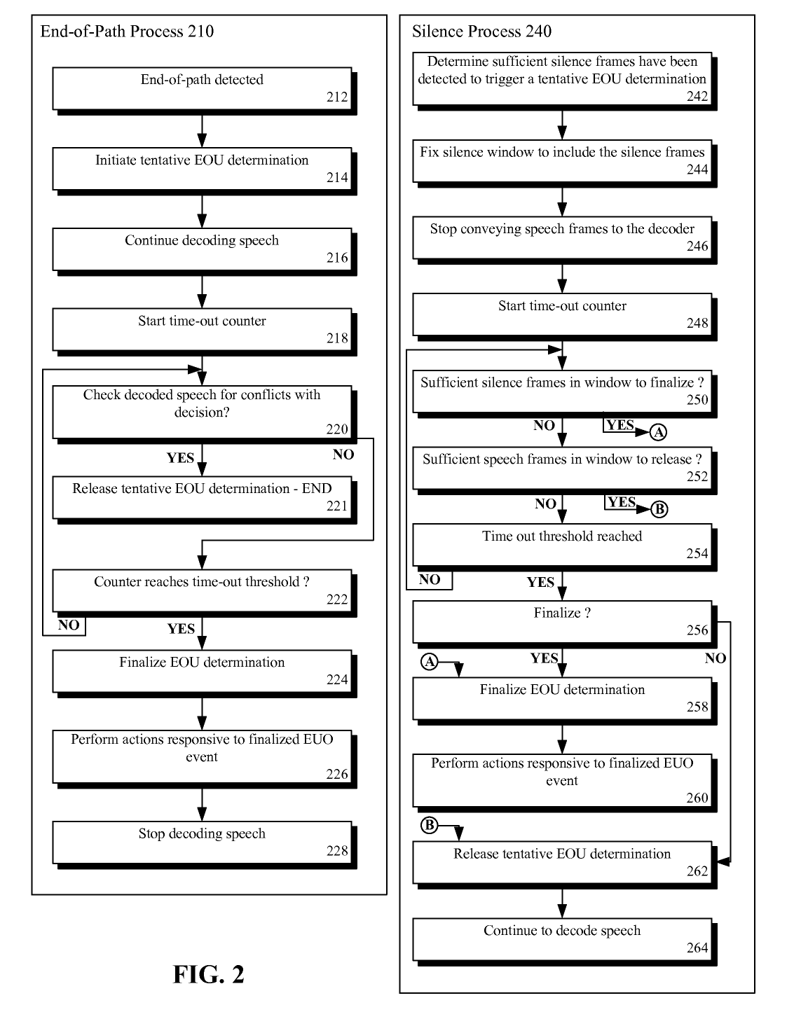

End-of-path process 210 illustrated in FIG. 2 shows a series of steps conducted when the end-of-path manager 132 is involved in an EOU determination. In step 212, an end-of-path event can be detected by manager 132, which can trigger a tentative EOU event, as shown in step 214. In step 216, speech frames can continue to be decoded after the tentative EOU. A time out counter can be started in step 218. In step 220, a check can be performed against the decoded speech, to determine whether the end-of-path occurrence was unintentional or should otherwise be withdrawn. For example, a decoded frame including content such as “no, that's not what I meant . . . ” can be indicative of an erroneous end-of-path occurrence. When the newly decoded speech is indicative of a problem, the process 210 can progress to step 221, where the tentative EOU determination can be withdrawn and the process 210 can end. Otherwise, the process 210 can progress to step 222, where a check can be made to see if the counter has reached the finalization time-out threshold. This threshold can be externally configured, such as by an application, by providing a finalization time-out value as one of the finalization parameters 114. If the timeout threshold is not reached the process can loop back to step 220.

When the finalization time-out expires, the process can progress from step 222 to step 224, where the EOU event can be finalized. In step 226, responsive to the finalized EOU event, a set of actions suitable for the decoded speech and/or state of the speech enabled device can be performed. One of the suitable actions can be to generate result 116. Additionally, the decoding of speech frames can be halted once the EOU event has been finalized, as shown by step 228.

The silence process 240 illustrated in FIG. 2 shows a series of steps conducted when the silence EOU handler 123 is involved in an EOU determination. Process 240 can begin in step 242 when a determination is made that a sufficient quantity of silence frames has been detected to trigger a tentative EOU determination. Process 240 can rely upon a number of silence frames contained within a window of frames when making silence based EOU determinations instead of relying upon a continuous set of silence frames. For example, when a silence threshold percentage is reached or exceeded, a silence window can be fixed to include the evaluated frames, as shown by step 244. Use of a sliding window instead of a using a fixed number of continuous silence frames can provide better performance in a noisy environment, where false speech determinations are expected without negatively impacting accuracy or inducing significant processing latencies.

Once the silence window is fixed and the tentative EOU determination made, the decoding of speech labeled frames can be halted, as indicated by step 246. Halting the decoding process when a silence situation is believed to exist can conserve processing resources. In step 248, a time-out counter 142 can be started. New frames from the audio stream 112 continue to be labeled by labeler 122 at this time. While the time-out counter is less than the finalization time out threshold 144, a quantity of speech and/or silence frames within the window can be intermittently checked. This permits the process 240 to take immediate action, when it becomes evident that tentative EOU determination should be either finalized or released. When no preliminary determination is possible, the window can be allowed to fill and/or the time-out counter can reach the finalization threshold, at which point a determination can be made.

Accordingly, step 250 checks to see if a sufficient number of silence frames exist to finalize the tentative EOU determination. If so, the process can progress to step 258, where finalization actions can be performed. Otherwise, step 252 can execute, where a determination as to whether sufficient quantities of speech frames are present in the window to release the tentative EOU determination. If so, the process can progress to step 262, where release actions can execute. Otherwise, a current value of the time-out counter can be compared against the finalization time out threshold (or the silence window can fill up in a different implementation). When the time-out event has not occurred, the process can loop back to step 250, where after a time another check for sufficient silence frames can be performed.

After the time-out event occurs, a decision can be made in step 256 to finalize the tentative EOU determination or not. A decision to finalize results in the process progressing from step 256 to step 258, where a decision to release the tentative determination results in the process progressing from step 256 to step 262. In step 258, the EOU determination can be finalized. In step 260, actions can be performed responsive to the finalized EOU determination. For example result handler 130 can initiate a programmatic action or can produce results 116, which causes another programmatic component to take actions relating to the received result 116. In step 262, a tentative EOU determination can be released and the previously halted decoder 126 can resume decoding speech frames, as shown by step 264. Speech frames accumulated when the decoder 126 was halted (in step 246) can be queued to be processed when decoding is resumed in step 264.

To illustrate by example, a sliding silence window can be fixed when at least eight out of the last ten frames are labeled as silence. The window can be created to contain thirty frames. After the window is fixed, so that it includes the eight silence frames of eight to ten sequentially received frames, subsequent frames can be placed in the now fixed window during a time period when the tentative EOU determination has yet to be finalized. When either the window fills or when the time out period expires, the determination can be finalized and/or released. Additionally, a speech exit threshold can be established for a sufficient number of speech frames in a window (e.g., seven frames) for terminating the finalization period early. That is, after the speech exit threshold has been reached or surpassed, the tentative EOU determination to be immediately released (e.g., ignored) and the speech processing system can resume normal input processing operations. A silence exist threshold can also be established for a sufficient number of silence frames in a window (e.g., twenty two) to terminate the finalization period early with a finalized EOU result.

As used herein, the speech processing system 110 can be any computing device or set of computing devices able to perform speech recognition functions, which include an EOU feature. The speech processing system 110 can be implemented as a stand-alone server, as part of a cluster of servers, within a virtual computing space formed from a set of one or more physical devices, and the like. In one embodiment, functionality attributed to the EOU detector 140, the decoder 126, and the like can be incorporated within different machines or machine components.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A system for determining end of utterance events (EOU) comprising:
a frame based segmenter configured to segment an incoming audio stream into a sequence of frames;
a frame labeler configured to label frames created by the frame based segmenter as silence frames and as speech frames;
a decoder configured to match audio contained in speech frames against entries in a speech recognition grammar and to perform programmatic actions based upon match results;
a silence end of utterance handler configured to initiate a tentative end of utterance event when a number of silence frames within a sequence of frames exceeds a previously defined threshold, wherein the silence end of utterance handler is capable of making a final end of utterance determination before a silence frame window is completely full;
an end-of-path manager configured to initiate a tentative end of utterance event when an end of a path of an enabled recognition grammar is determined; and
an end of utterance detector configured to establish a waiting period and a set of conditions for converting a tentative end of utterance event into a finalized end of utterance event and for releasing a tentative end of utterance event that is not to be finalized.

2. The system of claim 1, wherein the waiting period comprises an application configurable parameter specifying a duration for the waiting period.

3. The system of claim 1, wherein said system is part of a turn based speech processing system configured to perform speech processing operations for a plurality of applications in real time, each application being able to provide application specific parameters relating to the end of utterance determinations.

4. The system of claim 3, wherein said system is part of a middleware solution configured to provide speech processing capabilities.

5. The system of claim 1, wherein when silence end of utterance handler establishes a tentative end of utterance event, subsequent frames labeled between the tentative end of utterance event and a time that the tentative event is finalized or released by the end of utterance detector that are labeled as speech frames which would otherwise be sent to the decoder for handling are not sent to the decoder for handling.

6. The system of claim 5, wherein the end of utterance detector establishes a finalization time out period for finalizing a tentative end of utterance event, wherein when the tentative end of utterance event was initiated by the silence end of utterance handler, and when a number of frames labeled as speech subsequent to the tentative end of utterance event exceeds a previously configured threshold, the tentative end of utterance event is released, and speech frames are again sent to the decoder for handling.

7. The system of claim 1, wherein the end of utterance detector establishes a finalization time out period for finalizing a tentative end of utterance event, wherein when the tentative end of utterance event was initiated by the end-of-path manager, speech frames continue to be decoded until the finalization time out period expires.

8. The system of claim 7, wherein the end of utterance detector releases the tentative end of utterance event when decoded speech content processed between a time the tentative end of utterance event occurred and before the finalization time out period expired indicates that an end of path determination that initiated the tentative end of utterance event is to be retracted based upon the decoded speech content.

9. Software for determining an end of utterance event comprising:
a silence component configured to initiate a silence induced end of utterance event based upon a number sequential frames labeled as silence that are received, wherein said silence component is capable of making a final end of utterance determination before a silence frame window is completely full;
a path component configured to initiate an end-of-path induced end of utterance event based upon programmatic determinations that terminal nodes of recognition grammar paths for a speech input have been reached; and
a finalization component configured to delay determinations of end of utterance events initiated by the silence component and the path component for a defined duration, to perform at least one determination as to whether the initiated end of utterance event is to be finalized, and then to either finalize the initiated end of utterance event or to ignore the initiated end of utterance event based upon the performed determination, wherein the silence component, the path component, and the finalization component comprise software containing set of programmatic instructions for causing a machine executing the programmatic instructions to perform instruction defined actions, wherein said software is digitally encoded in a computer readable media.

10. The software of claim 9, wherein the defined duration is externally configurable via an input parameter.

11. The software of claim 9, wherein the defined duration is specified by applications using said software for end of utterance determinations.

12. The software of claim 9, wherein between a silence initiated end of utterance event and a determination by the finalization component occurring after the delay, a decoding of audio frames labeled as speech is halted.

13. The software of claim 12, wherein the finalization component determines whether to finalize the initiated end of utterance event or to ignore the initiated end of utterance event based upon labels associated with frames received subsequent to the initiated end of utterance event.

14. The software of claim 9, wherein between an end-of-path induced end of utterance event and a determination by the finalization component occurring after the delay, a decoding of audio frames labeled as speech is performed.

15. The software of claim 14, wherein results from the performed decoding determine whether the finalization component finalizes the initiated end of utterance event or ignores the initiated end of utterance event.

16. A method for determining end of utterance events in a speech processing situation comprising:
segmenting an incoming audio stream into a plurality of frames;
labeling each of said frames as frames containing speech or silence;
speech recognizing at least one of the speech containing frames of audio;
determining a number of sequential frames within a window of frames exceeds a previously established silence frame threshold, which causes a tentative end of utterance determination to be made based upon a quality of detected silence frames;
pausing a routing of subsequent frames labeled as speech to a decoder while the tentative end of utterance is pending a finalizing determination;
continuously adding frames to a silence frame window;
while frames are being added to the silence frame window, determining whether a sufficient number of silence or speech frames are present in the window to make an immediate finalizing determination;
when a sufficient number of frames is determined, immediately making a finalization determination before the silence frame window is full; and
taking appropriate suitable programmatic actions based upon the finalization determination.

17. The method of claim 16, further comprising:
receiving an application specific value that defines the sufficient number silence or speech frames needed within the silence frame window to make the immediate finalizing determination.

18. The method of claim 16, wherein said steps are performed as part of a dual factor technique for end of utterance determinations, wherein one factor is a quantity of silence frames received in close proximity to each other in a continuous series of frames and wherein another factor is an based upon whether an end-of-path is reached.

19. The method of claim 16, wherein said steps of claim 16 are performed by at least one machine in accordance with at least one computer program stored in a computer readable media, said computer programming having a plurality of code sections that are executable by the at least one machine.
